(19) United States
(12) Patent Application Publication
(10) Pub. No.: US 2022/0179375 A1
(43) Pub. Date: Jun. 9, 2022

(54) HUMAN-MACHINE INTERFACE WITH IMAGING APPLICATION

(71) Applicant: Solar Turbines Incorporated, San Diego, CA (US)

(72) Inventors: Andrea Soldi, Maccagno (IT); Vincent E. Pyka, San Diego, CA (US)

(73) Assignee: Solar Turbines Incorporated, San Diego, CA (US)

(21) Appl. No.: 17/112,678

(22) Filed: Dec. 4, 2020

(51) Int. Cl. G05B 15/02; G06F 9/4401; G06F 8/61; F02C 7/32

(52) U.S. Cl. CPC G05B 15/02; G06F 9/441; F02C 9/00; F02C 7/32; G06F 8/63

(57) ABSTRACT

A human-machine interface (HMI), HMI system, turbomachinery package, and method of modifying a partition of an HMI are disclosed. The HMI comprises a first partition storing a first operating system exclusively supporting a primary application; and a second partition storing a second operating system exclusively supporting an imaging application. The HMI system comprises the HMI; an external computing device; a serial cable; and, optionally, a network cable. The turbomachinery package comprises a housing; a gas turbine; a plurality of sensors; a plurality of actuators; and an HMI. The imaging application may be an image deploy function, an image back-up function, and/or an image restore function, any of which can be executed without the use of removable media.

### TECHNICAL FIELD

The present disclosure generally relates to human-machine interfaces and, more specifically, relates to human-machine interfaces having more than one operating system.

### BACKGROUND

A human-machine interface (“HMI”) is an interface or dashboard connecting a human user to a machine, device or system. An HMI may be used to display key indicators of a monitored system and/or to receive and convey user commands to that system. For example, a control system HMI for a turbomachinery package may display various process variables, such as an airflow rate, fuel flow rate, ambient temperature, and so on, for an operator to interpret. Due to their versatility, HMIs can be found in nearly all industries, including energy, transportation, utilities, manufacturing, and the like, and can even be found in common household appliances.

A single HMI may be one of many identical dashboards in a fleet of HMIs running the same hardware and software systems, the latter comprising an operating system (“OS”) and application software (“applications”). In some cases, the software systems may require periodic updates, in which case a newer version of the software is loaded onto every HMI of the same fleet. In other cases, individual HMIs may require software repairs, in which case a fresh version of the software is loaded (or an older version is restored) onto that HMI. Either scenario presents a problem in situations where the HMI is located in a remote or isolated location. Traditionally, to update or repair an HMI's software, an image of the most current software is loaded onto a removable media device, such as a universal serial bus (“USB”) or a CD-ROM, and carried onsite by field engineers for subsequent file transfer. However, this method has several flaws, primarily in the form of security risks, as any misplacement of the removable media device endangers the trade secrets and intellectual property of the HMI owner. Another known method of updating an HMI's software involves connecting the dashboard to a remote server via internet connection and downloading the files therein. However, this option is often prohibited by the isolated nature of some HMIs and the high cost of networking infrastructure.

One example of prior art is found in U.S. Pat. No. 7,930,531, which discloses a multi-partition USB device configured for transferring an OS image to a host computer. Unfortunately, like the state of the art, the device and method taught therein centers on a USB device, a la removable media, which may be undesirable for transferring sensitive software. Accordingly, the prior art has failed to provide an HMI capable of being securely imaged and a method of securely imaging an HMI, especially where the HMI is located in a remote operating environment.

### SUMMARY OF THE DISCLOSURE

According to one aspect of the present disclosure, a human-machine interface system configured for imaging applications is disclosed. The human-machine interface system comprises a human-machine interface having a first partition storing a first operating system supporting a primary application; and a second partition storing a second operating system supporting an imaging application to modify the first partition, the imaging application being selected from the group consisting of: image deploy, image back-up and image restore. The human-machine interface runs the first operating system at a separate time from the second operating system.

According to another aspect of the present disclosure, a turbomachinery package with human-machine interface is disclosed. The turbomachinery package comprises a housing; a gas turbine supported by the housing and including an air intake, a compressor, a combustion chamber, and a turbine; a plurality of sensors connected to the gas turbine and configured to provide signals; a plurality of actuators connected to the gas turbine and configured to receive signals; and a human-machine interface configured to operatively receive signals from the plurality of sensors and operatively provide signals to the plurality of actuators. The human-machine interface further includes a first partition storing a first operating system supporting a primary application; a second partition storing a second operating system supporting an imaging application to modify the first partition, the imaging application being selected from the group consisting of: image deploy, image back-up and image restore; an input device; and an output device.

According to a third aspect of the present disclosure, a method of modifying a first partition of a human-machine interface is disclosed. The method comprises providing a human-machine interface having a first partition and a second partition; configuring the first partition to store a first operating system supporting a primary application; configuring the second partition to store a second operating system supporting an imaging application to modify the first partition, the imaging application being selected from the group consisting of: image deploy, image back-up and image restore; encrypting the second partition; and booting from the first partition storing the first operating system during a normal operation.

These and other aspects and features of the present disclosure will be more readily understood after reading the following detailed description in conjunction with the accompanying drawings.

### BRIEF DESCRIPTION OF THE DRAWINGS

FIG. 1 is a perspective view of a turbomachinery package with human-machine interface according to one embodiment of the present disclosure.

FIG. 2 is a diagrammatical representation of a human-machine interface according to another embodiment of the present disclosure.

FIG. 3 is a diagrammatical representation of a human-machine interface system including a human-machine interface and an external computing device according to another embodiment of the present disclosure.

FIG. 4 is a flowchart illustrating a method of setting up a human-machine interface and running a primary application according to another embodiment of the present disclosure.

FIG. 5 is a flowchart illustrating a method of setting up a human-machine interface, connecting an input device and an output device, and running an imaging application according to another embodiment of the present disclosure.

FIG. 6 is a flowchart illustrating a method of setting up a human-machine interface, connecting an external computing device, and running an imaging application according to another embodiment of the present disclosure.

FIG. 7 is a flowchart illustrating a method of setting up a human-machine interface system, connecting an external computing device, and running an imaging application according to another embodiment of the present disclosure.

### DETAILED DESCRIPTION

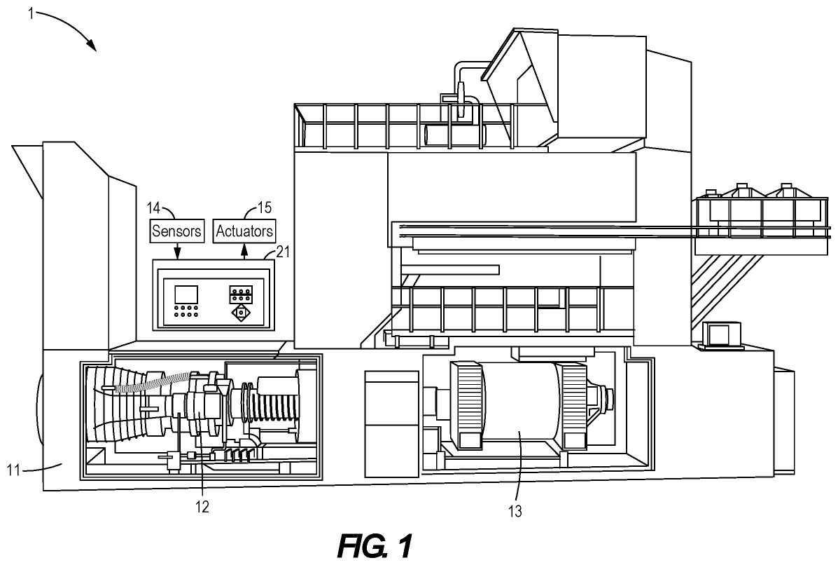

Referring now to the drawings, and with specific reference to FIG. 1, a perspective view of a turbomachinery package in accordance with the present disclosure is generally referred to by a reference numeral 1. The turbomachinery package 1 may be a mechanical drive package only, i.e. for generating mechanical power from oil, gas, and other fuels. Alternatively, and as depicted in FIG. 1, the turbomachinery package 1 may be a gas turbine power plant, i.e. for generating electrical power from oil, gas, and other fuels. It may include at least a housing 11, a gas turbine 12 supported by the housing 11, and a generator 13 supported by the housing 11 and driven by the gas turbine 12. The gas turbine 12 may further comprise an air intake, compressor, combustion chamber, turbine and any other commonly associated components; and the generator 13 may further comprise a rotor, stator, and any other commonly associated components. It should be understood that the turbomachinery package 1 may be of variable size and power output, may be designed to operate in any number of environments, may be a fully independent package or may be coupled to a larger combined-cycle system, and/or may be stationary or mobile in nature.

A plurality of sensors 14 connected to the gas turbine 12 are configured to provide signals to a computer, controller, HMI, or the like. For example, the plurality of sensors 14 may measure a temperature and pressure of the combustion chamber, a speed of the turbine, a vibration frequency of the compressor, and so on. Additionally, a plurality of actuators 15 connected to the gas turbine 12 are configured to receive signals from the computer, controller, or HMI and subsequently adjust an operation of the gas turbine 12. For example, the plurality of actuators 15 may manipulate a main fuel flow rate valve, a top-hat fuel rate valve, a pilot fuel flow rate valve, a bypass valve, and so on.

Monitoring and control of the gas turbine 12 may be handled by a human user. Therefore, the turbomachinery package 1 further includes an HMI 21 that can improve communication between the user and the gas turbine 12. More specifically, the HMI 21 is configured to operatively receive signals from the plurality of sensors 14 and to operatively provide signals to the plurality of actuators 15. For example, information about the temperature and pressure of the combustion chamber, the speed of the turbine, and the vibration frequency of the compressor may be relayed to the HMI 21 and displayed in numerical or graphical form on a screen of the HMI 21. Similarly, the main fuel flow rate valve, top-hat fuel rate valve, pilot fuel flow rate valve and bypass valve may be governable from a dial, switch, or touchscreen of the HMI 21, which relays control signals to the corresponding actuator 15. It should be understood that any number of operations, input signals, and output signals may be handled by the HMI 21 depending on specific applicational requirements. It should further be understood that any number of intervening components or systems may exist between the HMI 21 and the sensors 14 and actuators 15 of the gas turbine 12.

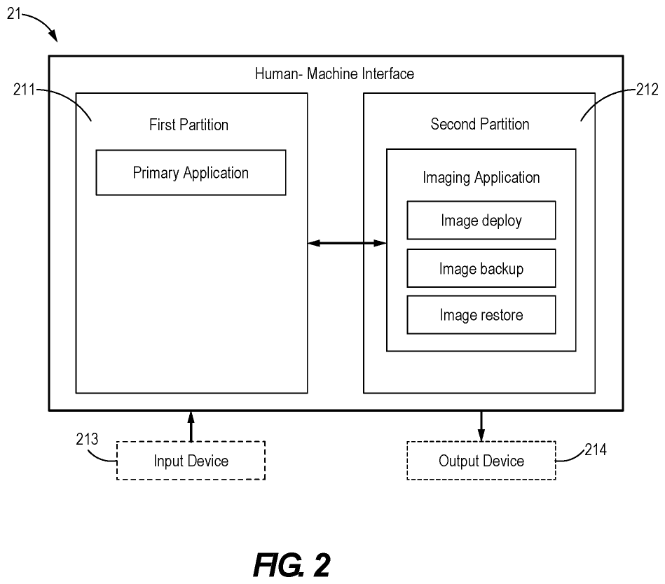

Turning now to FIG. 2, a diagrammatical representation of the HMI 21 according to the present disclosure is shown in greater detail. The HMI 21 may be one of many identical HMIs 21 in a fleet of turbomachinery packages, each sharing similar or even identical hardware and software systems. Each HMI 21 of the fleet may be loaded with software for executing various programs, where the programs directly related to an operation of the associated machine or system will be referred to as a primary application. The software may require periodic updates or repairs, in which case a user, such as a field engineer, may need to travel onsite and reimage the HMI 21, i.e. install a new version of its software or restore the machine to an older version of its software. While the HMI 21 may be part of the turbomachinery package 1, it may also exist in any number of other, unrelated use cases. For example, the HMI 21 may instead facilitate communication between a user and a work machine, between a user and a medical device, between a user and a manufacturing machine, etc.

To improve software security and ease of use, the HMI 21 is capable of backing-up and restoring an image of its primary application software without connecting it to any removable media. Furthermore, when an external computing device, such as a specially configured laptop, is introduced, a new image of the primary application software may be securely deployed to the HMI 21, again bypassing the need for removable media. The foregoing is accomplished by way of partitioning a memory of the HMI 21 into a first partition 211 loaded with the primary application software and a second partition 212 loaded with imaging application software, as detailed below.

The HMI 21 may comprise a memory in the form of a computer-readable medium, the memory being partitioned into a first partition 211 and a second partition 212 through a fixed partition, such that the two partitions 211, 212 are non-overlapping, unmovable and static. The first partition 211 is configured to store a first operating system exclusively supporting a primary application associated with a normal operation of the HMI 21, which may be, for example, a monitoring program for the turbomachinery package 1. In a preferred embodiment, the first operating system is a Windows®-based operating system. The second partition 212 is configured to store a second operating system exclusively supporting an imaging application designed to modify the first partition 211. The imaging application includes an image deploy function, which installs a new or updated version of the first partition (including the first operating system and primary application) onto the first partition 211; an image back-up function, which saves an image of the first partition into a back-up file, optionally stored on the second partition 212; and an image restore function, which repristinates the image of the first partition from the stored back-up file to the first partition 211. In a preferred embodiment, the second operating system is a Linux®-based operating system.

The HMI 21 can only boot or reboot from a single partition 211, 212 and operating system at a time and never concurrently runs both operating systems. During normal operation of the HMI 21, i.e. when using the primary application, only the first partition 211 is active, and the second partition 212 is inaccessible. In an embodiment, when the first partition 211 is active, the second partition 212 is completely powered off and/or encrypted, where the encryption protocol may be chosen according to specific applicational requirements. In another embodiment, the HMI 21 may be configured to default boot or reboot from the first partition 211, requiring external intervention to access the second partition 212.

For certain use cases, the HMI 21 may be a “headless” device, one devoid of any input or output devices and therefore incapable of either giving feedback to a user or receiving commands from the user. In such a case, and where the HMI 21 default boots to the first partition 211, it can be understood that the second partition 212 may never be accessed. Therefore, in some embodiments, the HMI 21 further comprises an input device 213 and an output device 214 operatively connected to the HMI 21. The input device 213 may be, for example, a keyboard, a mouse, a trackpad, a touchscreen, a microphone, a joystick, or other piece or pieces of equipment capable of receiving user controls and sending them to the HMI 21. Likewise, the output device 214 may be, for example, a monitor, a display, a speaker, a projector, a headphone, a plotter, or other piece of pieces of equipment capable of converting and conveying information to the user. Accordingly, the input device 213 and the output device 214 allow the user to command the HMI 21 to boot or reboot into the second partition 212 in order to run the imaging application. From there, the user may execute the image back-up function or, if a back-up file is already stored on the second partition 212, the image restore function.

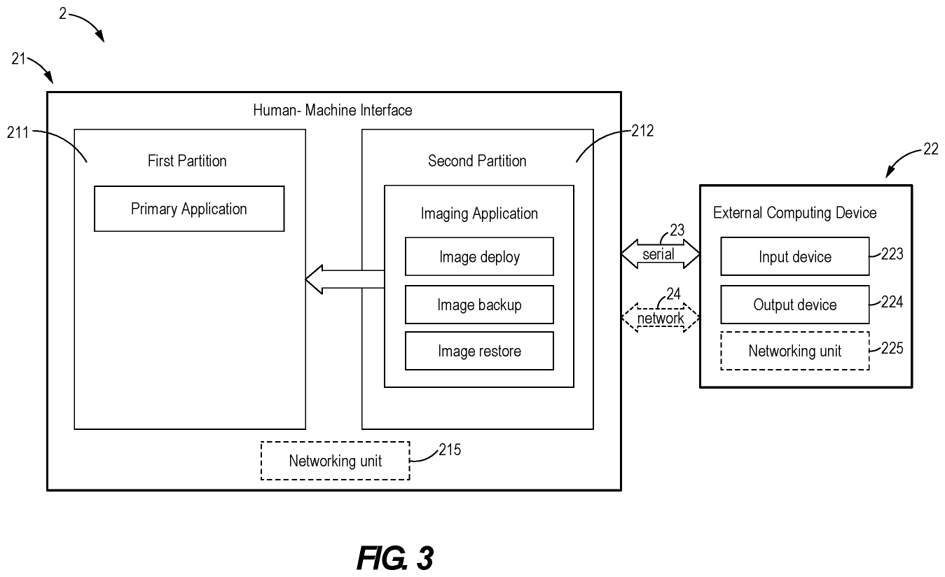

Turning now to FIG. 3, a diagram representation of an HMI system in accordance with the present disclosure is generally referred to by a reference numeral 2. The HMI system 2 comprises the HMI 21, an external computing device 22, a serial cable 23 and, in some embodiments, a network cable 24. The HMI system 2 improves upon the HMI 21 alone by allowing the imaging application of the HMI 21 to utilize the external computing device 22.

In this embodiment, the HMI 21 includes a first partition 211 storing a first operating system exclusively supporting a primary application, a second partition 212 storing a second operating system exclusively supporting an imaging application to modify the first partition 211 and, optionally, an HMI networking unit 215. The external computing device 22 comprises an input device 223, an output device 224 and, optionally, an external networking unit 225. The external computing device 22 may be any stationary or portable computing device, for example, a laptop, notebook, tablet, chrome book, mobile device, or the like, capable of serial communication and/or network communication with the HMI 21. It is worth mentioning that the input device 223 of the external computing device 22 operates analogously to the input device 213 of the HMI 21, and may even be the same device. Likewise, the output device 224 operates analogously to the output device 214, and may even be the same device.

With continued reference to FIG. 3, the HMI system 2 may further comprise a serial cable 23 connecting the external computing device 22 and the HMI 21. The serial cable 23 may be any cable used to transfer information using a serial communication protocol and be configured to transfer an input or an output from the external computing device 22 to the HMI 21, or vice versa. In an embodiment, the serial cable 23 connection may be programmed as a point-to-point connection using a custom, serial encryption protocol, although other connection protocols are also contemplated.

Where the HMI 21 is a “headless” device, the serial cable 23 enables the user to operatively communicate with the HMI 21 through the external computing device 22. In other words, the input device 223 and the output device 224 can be used to substitute the input device 213 and output device 214, respectively. For example, the user may operate a keyboard (223) and a display (224) of a laptop (22) to command the HMI 21, where the serial cable 23 communicates at least keystroke and display information. Accordingly, the external computing device 22 allows the user to boot or reboot the HMI 21 into the second partition 212 in order to run the imaging application. From there, the user may execute the image back-up function or, if a back-up file is already stored on the second partition 212, the image restore function.

In an embodiment, the HMI system 2 may comprise a network cable 24 connecting the external computing device 22 and the HMI 21. The network cable 24 may be any cable designed to transfer data between two network devices and be configured to transfer an image from the external computing device 22 to the HMI 21, or vice versa. In an embodiment, the network cable 24 connection may be programmed as a point-to-point connection using a custom, network encryption protocol, although other connection protocols are also contemplated.

If image transfer capabilities are established between the HMI 21 and the external computing device 22 via the network cable 24, the imaging application can execute any of the image deploy, image back-up, and image restore functions between the two. More specifically, with regards to the image deploy function, the imaging application may install a new or updated version of the first operating system and the primary application from the external computing device 22 onto the first partition 211 through the network cable 24. With regard to the image back-up function, the imaging application may save a current image of the first partition 211 into a back-up file, to be stored on the second partition 212 and/or the external computing device 22 through the network cable 24. With regard to the image restore function, the imaging application may repristinate the image of the first partition from the stored back-up file to the first partition 211 from the second partition 212 and/or the external computing device 22 through the network cable 24.

In an embodiment of the HMI system 2, the HMI 21 further comprises an HMI networking unit 215 and the external computing device 22 further comprises an external networking unit 225, thereby enabling a wireless network connection between the HMI 21 and external computing device 22. The wireless network connection may use any protocol or connection standard commonly employed in the art between two network devices and be configured to transfer an input and an output from the external computing device 22 to the HMI 21, or vice versa. In another embodiment, the wireless network connection may be configured to transfer an image from the external computing device 22 to the HMI 21, or vice versa. In other words, the networking units 215, 225 and the connection formed therein may replace the serial cable 23, the network cable 24, or both cables. In an embodiment, the wireless network connection may be an encrypted point-to-point connection using a custom, network encryption protocol, although other connection protocols are also contemplated.

The present disclosure therefore allows for a standalone HMI to securely back-up and restore its own primary application software by configuring a second operating system exclusively supporting an imaging application. Furthermore, when an external computing device is introduced, the present disclosure allows for an HMI system to securely deploy, back-up, and restore a primary application software of the HMI from/to the external computing device. In either case, a removable media device is obviated.

For the purposes of this disclosure, the term “human-machine interface” or “HMI” refers to any user interface or dashboard having a hardware and/or software system used to connect a user with a machine, system, or device, and may also be known as a man-machine interface (“MMI”), Operator Interface Terminal (“OTT”), Local Operator Interface (“LOT”), or Operator Terminal (“OR”), among other terms. A “human-machine interface” may also refer to a specialized computer implemented as part of a larger machine, system, or device, otherwise known as an embedded PC, box PC, gateway computer, controller, industrial PC, or appliance PC, among other terms.

The term “computing device” or “computer” as used herein refers to any programmable, electronic machine that accepts data, such as analog and/or digital data, and processes, transforms, and/or manipulates the data into information usable by a user or other machine. A computer is typically operated under the control of instructions, otherwise known as software, stored in a memory often in the form of a computer-readable medium. The computer may be a standalone unit or may consist of a plurality of operatively interconnected units.

The term “computer-readable medium” refers to any storage and/or transmission medium that participates in providing instructions to a processor for execution. Such a computer-readable medium is commonly tangible and non-transient and can take many forms, including but not limited to, non-volatile media, volatile media, and transmission media, such as random access memory (RAM) and read only memory (ROM). Common forms of computer-readable media include, without limitation, floppy disks, hard disks, magnetic tape, digital video disks, and solid-state drives. Accordingly, the term as employed in the present disclosure is considered to include any tangible storage medium or prior-art recognized equivalents in which software files and data can be stored.

The term “application” as used herein refers to an application software, that is software designed to help the user perform specific tasks. Common consumer examples include satellite location and navigation software, social networking software, gaming software, word processing software, and the like; whereas common industry examples include automation software, simulation or visualization software, and supervisory control and data acquisition (“SCADA”) software. Application software is contrasted with operating system software, which manages a computer's hardware and allocates system resources for use by the application software, but typically does not directly perform tasks that benefit the user.

The term “operating system”, also known as an “OS”, refers to a low-level system software that handles the interface to a system's hardware and provides services for high-level applications. The functions of the operating system may include, without limitation, allocating hardware resources, generating processor schedules, performing tasks, and designating system memory. Operating systems typically comprise predetermined system files which are the first software loaded into a memory of a computing device after being powered on.

The term “system image”, “operating system image” or simply “image” as used herein refers to a serialized copy of the entire state of a partition stored in a non-volatile, computer-readable medium. The image is a file or set of files, typically in an .ISO or .IMG file format, storing an operating system software, application software, executables, and data files found in the original partition.

The term “memory partition” or simply “partition” refers to a division of a memory of a computing device, which may be in the form of a computer-readable medium, for use by different resident programs. A partition may be, fixed, variable, or dynamic, among other configurations.

### INDUSTRIAL APPLICATION

The present disclosure may find industrial applicability in any number of HMI applications where a secure method of installing, updating, or repairing the HMI's software system is desired. For example, it may be used in conjunction with the turbomachinery package shown in FIG. 1; it may be used in a different turbomachinery package, such as a gas compressor package, a mechanical drive package, an oil and gas generator package, or a complete power generation package; or it may be used in a different area of art altogether, such as in association with a work machine, a medical device, a manufacturing machine, a household appliance, and so on, where no limitation is intended herein. The HMI of the present disclosure may be particularly germane to remote and isolated applications, especially those requiring onsite travel for repairs and updates of the HMI's software systems, for example in a mobile power plant, an offshore gas turbine fleet, a marine vessel, and so on.

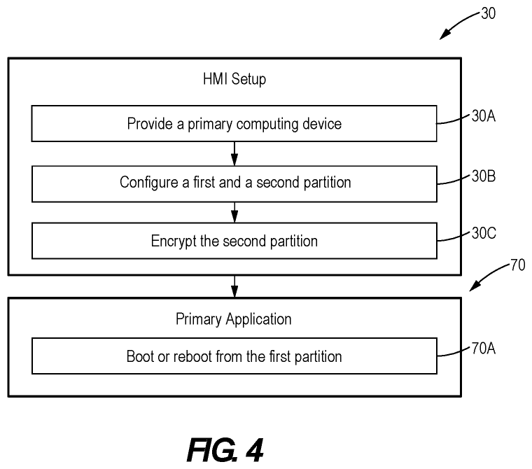

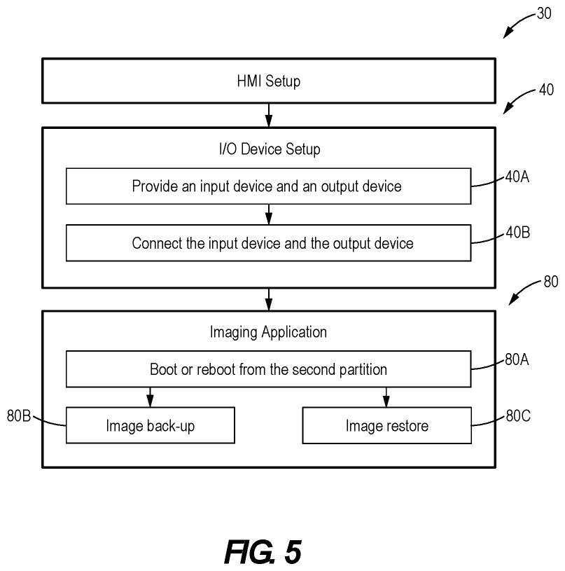

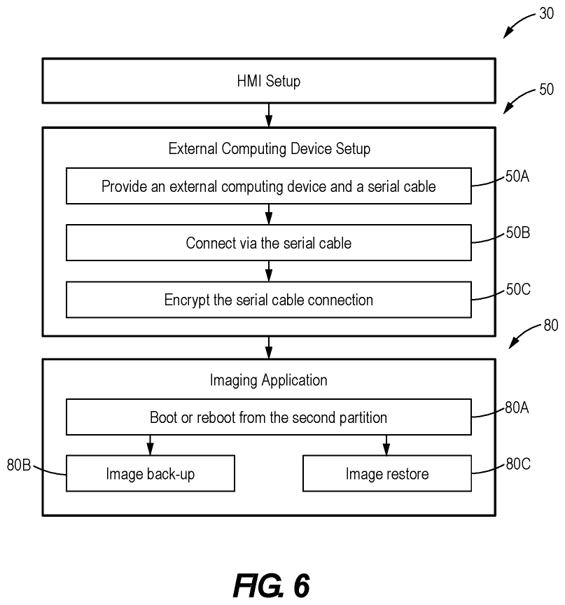

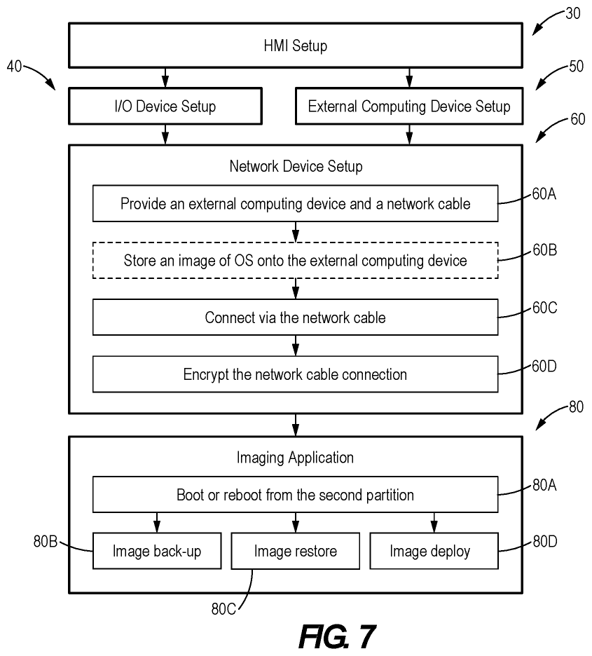

Turning now to FIGS. 4-7, several methods of modifying a partition of an HMI and running a primary application and/or an imaging application are shown in accordance with the present disclosure. According to the method shown in FIG. 4, a standalone HMI may run a primary application. According to the method shown in FIG. 5, a standalone HMI including an input device and an output device may run an imaging application. According to the method shown in FIG. 6, an HMI system including an HMI, an external computing device, and a serial cable may run an imaging application. Finally, according to the method shown in FIG. 7, an HMI system including an HMI, an external computing device, and a network cable may run an imaging application.

FIG. 4 is a flow chart illustrating a method of setting up a standalone HMI and running a primary application. An HMI setup stage 30 illustrates a setup procedure for a standalone HMI. First, an HMI comprising a first partition and a second partition in accordance with the present disclosure is provided (30A). Next, in 30B, the first partition is configured to store a first operating system exclusively supporting a primary application and the second partition is configured to store a second operating system exclusively supporting an imaging application to modify the first partition. In 30C, the second partition may be encrypted to protect the second operating system, imaging application, and associated files from both external access and unauthorized access by the first partition. With continued reference to FIG. 4, in a primary application stage 70, the normal operations of the HMI may be performed by booting or rebooting from the first partition storing the first operating system (70A). In an embodiment, the HMI may default boot from the first partition, and the second partition may be completely powered off and/or encrypted when the first partition is active.

FIG. 5 is a flow chart illustrating a method of setting up a standalone HMI including an input device and an output device and running an imaging application. The HMI is first setup according to the procedure outlined in HMI setup stage 30. Next, in an I/O device setup stage 40, information channels are created for a user to communicate with the HMI. In 40A, an input device and an output device in accordance with the present disclosure are provided. And in 40B, the input device and the output device are operatively connected to the HMI. Accordingly, the HMI is now capable of communicating with a user, who can proceed to the imaging application stage 80. As seen in 80A, the user may first boot or reboot from the second partition storing the second operating system. Once the imaging application is accessed, the user may execute an image back-up function (80B), which saves an image of the first partition into a back-up file; or the user may execute an image restore function (80C), which repristinates the image of the first partition from the stored back-up file to the first partition.

FIG. 6 is a flow chart illustrating a method of setting up an HMI system including an HMI, an external computing device and a serial cable; and running an imaging application. The HMI is first setup according to the procedure outlined in HMI setup stage 30. Next, in an external computing device setup stage 50, information channels are created for a user to communicate with the HMI. Specifically, in 50A, an external computing device comprising an input device and an output device, and a serial cable in accordance with the present disclosure are provided. In 50B, the external computing device is connected to the HMI via the serial cable; and in 50C, the serial cable connection is encrypted using a custom, point-to-point encryption protocol. The HMI is now capable of communicating with a user, who can proceed to the imaging application stage 80. As seen in 80A, the user may first boot or reboot from the second partition storing the second operating system. Once the imaging application is accessed, the user may execute the image back-up function (80B) or the image restore function (80C).

FIG. 7 is a flow chart illustrating a method of setting up an HMI system including an HMI, an external computing device and a network cable; and running an imaging application. The HMI is first setup according to the procedure outlined in HMI setup stage 30. Next, in either the I/O device setup stage 40, the external computing device setup stage 50, or both, information channels are created for a user to communicate with the HMI. Following, in a network communication device setup stage 60, additional information channels are created for one computing device to transfer an image to the other computing device. Specifically, in 60A, an external computing device and a network cable in accordance with the present disclosure are provided. Optionally, an image of the operating system and primary application are pre-loaded onto a memory of the external computing device (60B). In 60C, the external computing device is connected to the HMI via the network cable; and in 60C, the network cable connection is encrypted using a custom, point-to-point encryption protocol. Accordingly, the HMI is now capable of transferring and/or receiving image files, and the user can proceed to the imaging application stage 80. As seen in 80A, the user may boot or reboot from the second partition storing the second operating system. Once the imaging application is accessed, the user may execute the image back-up function (80B), the image restore function (80C), or the image deploy function (80D), which installs a new or updated version of the first operating system and the primary application from the external computing device onto the first partition. It is worth noting that the image deploy function (80D), unlike the image back-up function (80B) and image restore function (80C), is not possible without an external computing device and a network connection thereto, wired or otherwise.

The embodiments disclosed herein therefore provide significant improvements over the prior art in terms of reliability and system security. The HMIs, HMI systems, and methods provided may be employed in any location accessible to a user, in HMI fleets of any size, and in association with any number and variety of machines, devices, systems, and use cases.

What is claimed is:

1. A human-machine interface system configured for imaging applications, comprising:
a human-machine interface having:
a first partition storing a first operating system supporting a primary application; and
a second partition storing a second operating system supporting an imaging application to modify the first partition, the imaging application being selected from the group consisting of: image deploy, image back-up and image restore, wherein the human-machine interface runs the first operating system at a separate time from the second operating system.

2. The human-machine interface system according to claim 1, wherein the first operating system is a Windows®-based operating system and the second operating system is a Linux®-based system.

3. The human-machine interface system according to claim 1, wherein the human-machine interface boots from the first partition storing the first operating system during a normal operation.

4. The human-machine interface system according to claim 1, further comprising:
an input device operatively connected to the human-machine interface; and
an output device operatively connected to the human-machine interface.

5. The human-machine interface system according to claim 1, further comprising:
an external computing device having an input device and an output device.

6. The human-machine interface system according to claim 5, further comprising:
a serial cable connecting the human-machine interface and the external computing device, the serial cable being configured to transfer an input or an output.

7. The human-machine interface system according to claim 5, further comprising:
a network cable connecting the human-machine interface and the external computing device, the network cable being configured to transfer an image.

8. The human-machine interface system according to claim 5, wherein the human-machine interface further comprises an HMI networking unit; and wherein the external computing device further comprises an external networking unit.

9. A turbomachinery package with human-machine interface, comprising:
a housing;
a gas turbine supported by the housing and including an air intake, a compressor, a combustion chamber, and a turbine;
a plurality of sensors connected to the gas turbine and configured to provide signals;
a plurality of actuators connected to the gas turbine and configured to receive signals; and
a human-machine interface configured to operatively receive signals from the plurality of sensors and operatively provide signals to the plurality of actuators, including:
a first partition storing a first operating system supporting a primary application;
a second partition storing a second operating system supporting an imaging application to modify the first partition, the imaging application being selected from the group consisting of: image deploy, image back-up and image restore;
an input device; and
an output device.

10. The turbomachinery package according to claim 9, wherein the human-machine interface runs the first operating system at a separate time from the second operating system; and wherein the human-machine interface boots from the first partition storing the first operating system during a normal operation.

11. A method of modifying a partition of a human-machine interface, comprising:
providing a human-machine interface having a first partition and a second partition;
configuring the first partition to store a first operating system supporting a primary application;
configuring the second partition to store a second operating system supporting an imaging application to modify the first partition, the imaging application being selected from the group consisting of: image deploy, image back-up and image restore;
encrypting the second partition; and
booting from the first partition storing the first operating system during a normal operation.

12. The method of modifying according to claim 11, further comprising:
providing an input device and an output device; and
connecting, operatively, the input device and the output device to the human-machine interface.

13. The method of modifying according to claim 12, further comprising:
booting from the second partition storing the second operating system; and
backing-up an image of the first partition into the second partition using the imaging application.

14. The method of modifying according to claim 12, further comprising:
booting from the second partition storing the second operating system; and
restoring an image of the first partition from the second partition using the imaging application.

15. The method of modifying according to claim 11, further comprising:
providing an external computing device having an input device and an output device.

16. The method of modifying according to claim 15, further comprising:
providing a serial cable configured to transfer an input or an output;
connecting the human-machine interface and the external computing device via the serial cable; and
encrypting a serial cable connection.

17. The method of modifying according to claim 15, further comprising:
providing a network cable configured to transfer an image;
connecting the human-machine interface and the external computing device via the network cable; and
encrypting a network cable connection.

18. The method of modifying according to claim 15, further comprising:
providing an HMI networking unit connected to the human-machine interface and an external networking unit connected to the external computing device;
connecting the human-machine interface and the external computing device via a wireless network connection; and
encrypting the wireless network connection.

19. The method of modifying according to claim 15, further comprising:
storing an image of the first operating system into the external computing device;
booting from the second partition storing the second operating system; and
deploying the image of the first operating system from the external computing device using the imaging application.

20. The method of modifying according to claim 15, further comprising:
booting from the second partition storing the second operating system; and
backing-up an image of the first operating system into the external computing device using the imaging application.
